(19) United States
(12) Patent Application Publication
(10) Pub. No.: US 2011/0157901 A1
(43) Pub. Date: Jun. 30, 2011

(54) LIGHTING APPARATUS

(76) Inventor: Kevin Cho CHEN, Yongkang City (TW)

(21) Appl. No.: 12/977,450

(22) Filed: Dec. 23, 2010

(30) Foreign Application Priority Data
Dec. 31, 2009 (TW) 098146297

(51) Int. Cl. F21V 29/00; F21V 15/01

(52) U.S. Cl. 362/373; 362/375

(57) ABSTRACT

A lighting apparatus includes a lamp seat, a lighting unit, a housing, and an abutment unit. The lamp seat includes a support portion. The lighting unit is disposed on the lamp seat and includes a circuit board disposed on the support portion, and at least one lighting element mounted on the circuit board for emitting light. The housing surrounds and covers the lighting unit, and includes a cover flange connected to the lamp seat. The abutment unit is disposed between the housing and the lighting unit for abutting against and securing the circuit board on the support portion.

### CROSS-REFERENCE TO RELATED APPLICATION

This application claims priority of Taiwanese application no. 098146297 filed on Dec. 31, 2009.

### BACKGROUND OF THE INVENTION

1. Field of the Invention

The invention relates to a lighting apparatus, and more particularly to a lighting apparatus that uses light-emitting diodes and that is easy to assemble.

2. Description of the Related Art

Assembly of a conventional light-emitting diode (LED) lighting apparatus may require mounting multiple components using a combination of fasteners and a plurality of threaded bolts. The process may be unnecessarily complicated and inconvenient.

### SUMMARY OF THE INVENTION

An object of the present invention is to provide a lighting apparatus that is easy to assemble.

Accordingly, a lighting apparatus of the present invention includes a lamp seat, a lighting unit, a housing, and an abutment unit. The lamp seat includes a support portion. The lighting unit is disposed on the lamp seat and includes a circuit board disposed on the support portion, and at least one lighting element mounted on the circuit board for emitting light. The housing surrounds and covers the lighting unit, and includes a cover flange connected to the lamp seat. The abutment unit is disposed between the housing and the lighting unit for abutting against and securing the circuit board on the support portion.

An advantage of this invention is that the abutting unit secures the circuit board on the lamp seat after assembly.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of a lighting apparatus according to the present invention;

FIG. 2 is a partly sectional view of the first preferred embodiment;

FIG. 3 is an exploded perspective view of the second preferred embodiment of a lighting apparatus according to the present invention;

FIG. 4 is a partly sectional view of the second preferred embodiment;

FIG. 5 is an exploded perspective view of the third preferred embodiment of a lighting apparatus according to the present invention; and

FIG. 6 is a partly sectional view of the third preferred embodiment.

### DETAILED DESCRIPTION OF THE PREFERRED EMBODIMENTS

Before the present invention is described in greater detail with reference to the accompanying embodiments, it should be noted herein that like elements are denoted by the same reference numerals throughout the disclosure.

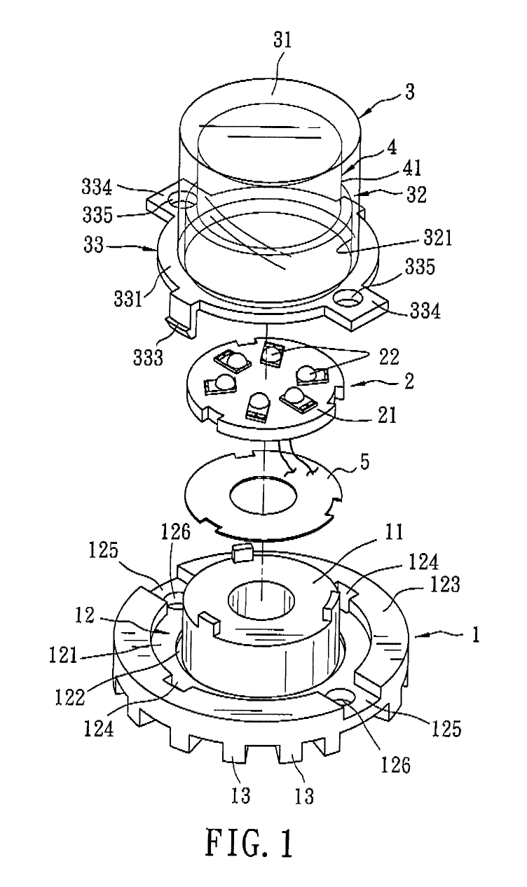

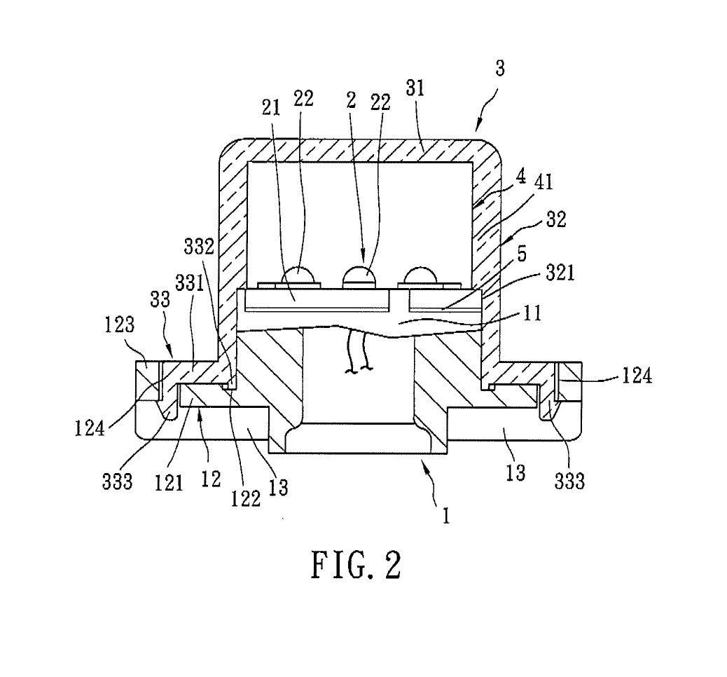

Referring to FIGS. 1 and 2, the first preferred embodiment of a lighting apparatus according to the present invention is shown to include a lamp seat 1, a lighting unit 2 mounted on the lamp seat 1, a spacer 5 that is composed of heat-conductive silicone disposed between the lamp seat 1 and the lighting unit 2, a housing 3 surrounding and covering the lighting unit 2, and an abutment unit 4 disposed between the housing 3 and the lighting unit 2. The disposition and mounting orientation of the aforementioned lighting apparatus is not limited to what is disclosed in the preferred embodiment, and the lighting apparatus may be oriented in various alternate positions, such as being rotated 90 degrees, being inverted, or being positioned at any other angle. The description below is based on what is shown in the Figures.

The lamp seat 1 is made of metal and includes an elongate hollow cylindrical support portion 11, an engaging portion 12 integrally formed with the base of the support portion 11, and a plurality of spaced apart heat dissipating parts 13 formed on a bottom side of the engaging portion 12. The engaging portion 12 includes a base plate 121 extending radially outward from the base of the support portion 11, an engaging channel 122 formed in a top face of the base plate 121 and surrounding the support portion 11, and a peripheral wall 123 protruding upward from a periphery of the base plate 121. The engaging portion 12 further includes a pair of engaging holes 124 formed around the support portion 11 and extending through the peripheral wall 123 and the base plate 121, a pair of notches 125 formed in a top face of the peripheral wall 123, and a pair of lower holes 126, each formed in a respective one of the notches 125 and extending through the base plate 121. The numbers of the notches 125 and the lower holes 126 may be increased or decreased, and are not limited to the numbers disclosed herein.

The lighting unit 2 includes a circuit board 21 disposed on top of the support portion 11, and six lighting elements 22 mounted on the circuit board 21 for emitting light. Each of the lighting elements 22 is a light emitting diode and emits light outward through the housing 3. The number of the lighting elements 22 may be increased or decreased according to need, and may be installed in quantities such as 1, 3, 4, 8, 12, etc. Since the designs of the connecting circuits and switches of the circuit board 21 and the lighting elements 22 are not the focus of this invention, they are not further detailed for the sake of brevity.

The spacer 5 is a washer with excellent heat conductance, and has a thickness of 0.5 mm. The spacer 5 is adhered between the support portion 11 and the circuit board 21 to seal the space between the support portion 11 and the circuit board 21 and to closely mount the lighting unit 2 to the lamp seat 1.

The housing 3 is made of light-transmissive plastic material, and includes an end wall 31 disposed above and spaced apart from the lighting unit 2, a peripheral wall 32 extending downward from a periphery of the end wall 31, and a cover flange 33 extending radially outward from a bottom of the peripheral wall 32 to be fixedly connected to the lamp seat 1. The peripheral wall 32 has an inner face 321 surrounding a periphery of the circuit board 21 and the support portion 11. The cover flange 33 includes a skirt 331 integrally connected to a bottom portion of the peripheral wall 32, an embedding ring 332 extending from an inner edge of the skirt 331, a pair of hooks 333 extending downward from the periphery of the skirt 331 to be inserted into and engaged with the engaging holes 124, a pair of mounting feet 334 that extend radially outward from the periphery of the skirt 331 and that are registered with the respective notches 125, and a pair of upper holes 335, each extending through a respective one of the mounting feet 334 and being registered with a respective one of the lower holes 126.

The skirt 331 is configured for being stacked on top of the base plate 121 and is received in an annular space between the support portion 11 and an inner radial face of the peripheral wall 123. The embedding ring 332 is configured for being embedded in and engaged with the engaging channel 122. Each of the hooks 333 is extended downward through a respective one of the engaging holes 124 to abut against a bottom side of the base plate 121. The mounting feet 334 are each registered with and embedded in a respective notch 125. The upper holes 335 are each registered with a respective lower hole 126 to form a corresponding channel to receive a corresponding connecting member (not shown) to fasten the housing 3 and the lamp seat 1 together. The corresponding channel may also be used to mount the housing 3 and the lamp seat 1 to a mounting location (not shown), such as a vehicle body, a building ceiling, a wall, etc., or wherever illumination is needed. The number of hooks 333 corresponds to the number of engaging holes 124, and the number of mounting feet 334 and upper holes 335 are the same as the number of notches 125 and lower holes 126.

The abutment unit 4 of this embodiment is formed on the housing 3, and includes an abutment portion 41 integrally formed with the inner face 321, disposed above the circuit board 21, and extending radially from the inner face 321 toward an axis of the housing 3 for abutting against the circuit board 21. The abutment portion 41 is formed as a column that extends upward from the circuit board 21 to connect with the end wall 31. However, in other embodiments, the abutment portion 41 may have a shorter length, be formed as a ring, or be composed of a plurality of spaced apart protrusions disposed above the circuit board 21. Hence, the design is not limited to what is disclosed.

For assembly, first the lighting unit 2 is placed on the spacer 5, which is placed on the support portion 11 of the lamp seat 1. Next, the housing 3 is placed on the lamp seat 1. The embedding ring 332 is embedded in and engaged with the engaging channel 122, the skirt 331 is stacked on the base plate 121 in the annular space between the support portion 11 and the inner radial face of the peripheral wall 123, each mounting foot 334 is engaged with the corresponding notch 124, and each hook 333 is extended into and engaged with the corresponding engaging hole 125 such that the abutment portion 41 of the abutment unit 9 abuts against and secures the circuit board 21 to the support portion 11. In this way, the housing 3 is mounted to the lamp seat 1, thus completing the assembly operation.

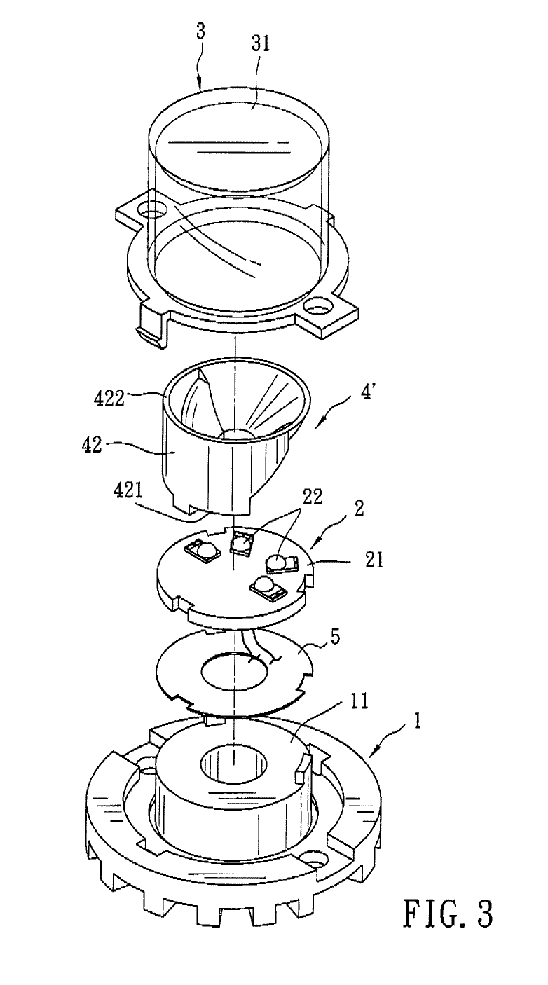

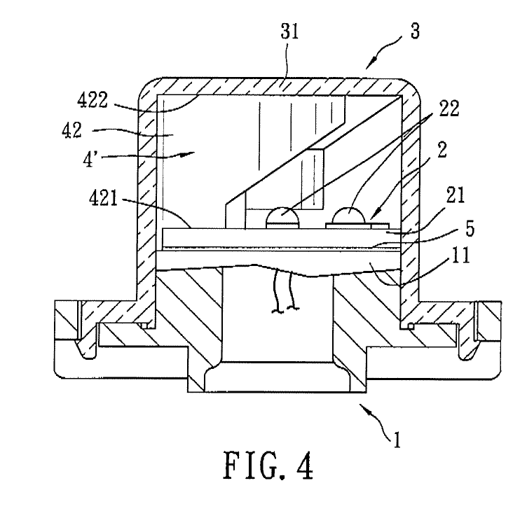

Referring to FIGS. 3 and 4, the second preferred embodiment of a lighting apparatus according to the present invention includes a lamp seat 1, a lighting unit 2, a spacer 5, a housing 3 and an abutment unit 4′. The second preferred embodiment differs from the first preferred embodiment in the structure of the abutment units 4, 4′. In this embodiment, the abutment unit 4′ has a reflector 42 that is disposed between the circuit board 21 and the end wall 31, that has a height at least equal to the distance between the circuit board 21 and the end wall 31, that reflects light emitted by the lighting elements 22, and that has a first reflector end 421 for abutting against the circuit board 21, and a second reflector end 422 disposed opposite to the first reflector end 421 for abutting against the end wall 31. For assembly, when the housing 3 is mounted on the lamp seat 1, the end wall 31 abuts against the reflector 42, and the reflector 42 in turn abuts against the circuit board 21 to secure the circuit board 21 to the support portion 11.

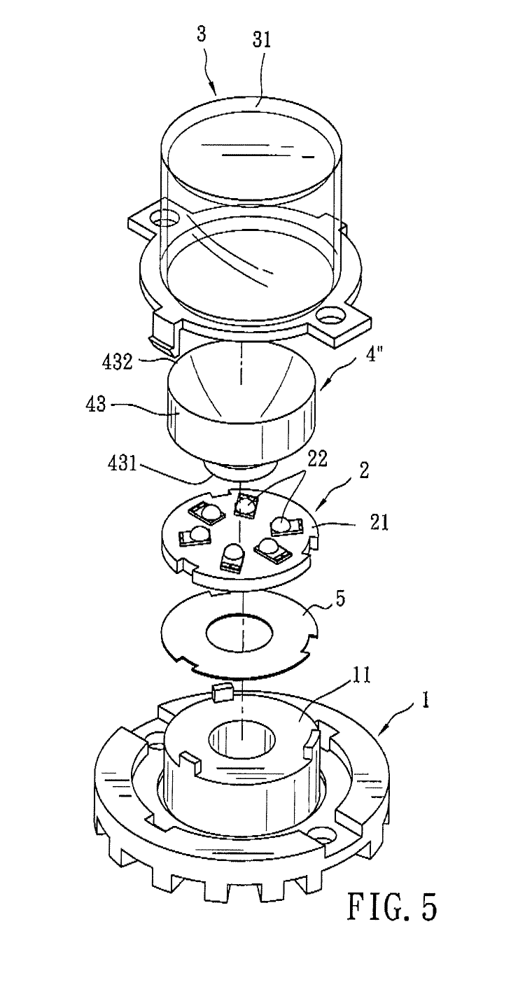

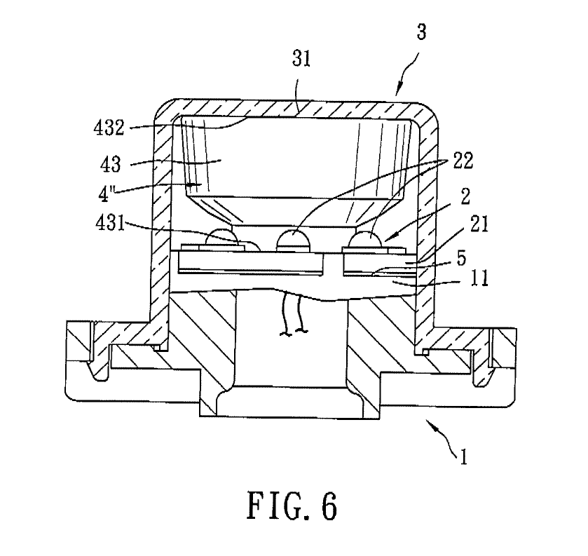

Referring to FIGS. 5 and 6, the third preferred embodiment of a lighting apparatus according to the present invention is almost identical to the second preferred embodiment. The third preferred embodiment includes a lamp seat 1, a lighting unit 2, a spacer 5, a housing 3, and an abutment unit 4″. The third preferred embodiment differs from the second preferred embodiment in the structures of the abutment units 4′, 4″. In this embodiment, the abutment unit 4″ has a light guide 93 that is mounted between the circuit board 21 and the end wall 31, that has a height at least equal to the distance between the circuit board 21 and the end wall 31, and that is for diffusing the light emitted by the lighting elements 22. The light guide 43 has a first end 431 for abutting against the circuit board 21 and a second end 432 disposed opposite to the first end 431 for abutting against the end wall 31. For assembly, when the housing 3 is mounted on the lamp seat 1, the end wall 31 abuts against the light guide 43, and the light guide 43 in turn abuts against and secures the circuit board 21 to the support portion 11.

In summary, when the housing 3 is mounted, the abutment unit 4,4′,4″ abuts against and secures the circuit board 21 to the lamp seat 1. In this manner, the fasteners used in the prior art for fastening the lighting unit 2 on the lamp seat 1 can be dispensed with.

While the present invention has been described in connection with what are considered the most practical and preferred embodiments, it is understood that this invention is not limited to the disclosed embodiments but is intended to cover various arrangements included within the spirit and scope of the broadest interpretation to encompass all such modifications and equivalent arrangements.

What is claimed is:

1. A lighting apparatus comprising:
a lamp seat including a support portion;
a lighting unit disposed on said lamp seat and including a circuit board disposed on said support portion, and at least one lighting element mounted on said circuit board for emitting light;
a housing surrounding and covering said lighting unit, and including a cover flange connected to said lamp seat; and
an abutment unit disposed between said housing and said lighting unit for abutting against and securing said circuit board on said support portion.

2. The lighting apparatus as claimed in claim 1, wherein said housing further includes an end wall spaced apart from said lighting unit, and a peripheral wall extending from a peripheral edge of said end wall, and being connected to said cover flange of said housing, and
wherein said peripheral wall has an inner face surrounding a periphery of said circuit board, said abutment unit including an abutment portion integrally formed with and extending radially inward from said inner face, and abutting against one side of said circuit board opposite said support portion.

3. The lighting apparatus as claimed in claim 1, wherein said housing further includes an end wall spaced apart from said lighting unit, and a peripheral wall extending from a peripheral edge of said end wall, and being connected to said cover flange of said housing, and
wherein said abutment unit includes a reflector disposed in said housing and disposed between said circuit board and said end wall, said reflector having a first reflector end abutting against said circuit board, and a second reflector end abutting against said end wall.

4. The lighting apparatus as claimed in claim 1, wherein said housing further includes an end wall spaced apart from said lighting unit, and a peripheral wall extending from a peripheral edge of said end wall, and being connected to said cover flange of said housing, and
wherein said abutment unit includes a light guide disposed in said housing and disposed between said circuit board and said end wall, said light guide having a first end abutting against said circuit board, and a second end abutting against said end wall.

5. The lighting apparatus as claimed in claim 1, wherein said lamp seat further includes an engaging portion that is integrally formed with a base of said support portion, said engaging portion being formed with a plurality of engaging holes around an outer periphery of said support portion, said cover flange including a plurality of hooks for engaging said engaging holes, respectively.

6. The lighting apparatus as claimed in claim 5, wherein said engaging portion further includes a base plate extending radially and outwardly from said support portion, said engaging portion being formed with an engaging channel in one side of said base plate that faces toward said housing, said engaging channel surrounding said support portion, said cover flange further including a skirt portion integrally connected to said peripheral wall, and a ring portion extending from said skirt portion for extension into said engaging channel.

7. The lighting apparatus as claimed in claim 5, wherein said lamp seat further includes a plurality of spaced-apart heat dissipating parts formed on one side of said engaging portion opposite said housing.

8. The lighting apparatus as claimed in claim 1, further comprising a spacer disposed between said lamp seat and said lighting unit, said spacer being made of a heat-conductive and electrically-insulating material.

9. The lighting apparatus as claimed in claim 8, wherein said spacer is made of silicone.

10. The lighting apparatus as claimed in claim 1, wherein said lighting element is a light emitting diode.
